(19) United States
(12) Patent Application Publication
(10) Pub. No.: US 2004/0153999 A1
(43) Pub. Date: Aug. 5, 2004

(54) System and method for managing operating systems

(76) Inventors: Takeshi Miyao, Hitachiota (JP); Hirokazu Kasashima, Hitachi (JP); Tomoaki Nakamura, Hitachinaka (JP); Hiroshi Ohno, Hitachi (JP); Tadashi Kamiwaki, Tokai (JP); Masahiko Saito, Mito (JP); Taro Inoue, Yamato (JP)

Correspondence Address: DICKSTEIN SHAPIRO MORIN & OSHINSKY LLP, 2101 L STREET NW, WASHINGTON, DC, 20037-1526, US

(21) Appl. No.: 10/761,403

(22) Filed: Jan. 22, 2004

Related U.S. Application Data
(63) Continuation of application No. 10/189,181, filed on Jul. 5, 2002.
Application No. 10/189,181 is a continuation of application No. 09/914,814, filed on Oct. 22, 2001.

(51) Int. Cl. G06F 9/44

(52) U.S. Cl. 717/128

(57) ABSTRACT

If a plurality of operating systems are running in one computer and each of those operating systems has its own managed time, which is different from others, then trace log information items collected by those operating systems and merged in order of their generated times may not be as they are generated actually. In order to avoid such a problem, therefore, the present invention provides an operating system management system with recording means for storing a check point trace in the operation trace information of each of those operating systems, thereby finding the correspondence among those check point traces by searching the operation trace information item of each operating system, then adding such additional information as a time difference, a counter value, etc. to the operation trace information. Thus, even when each operating system has its own managed time different from others, it is possible to manage the sequence of events recorded in those operating systems correctly, thereby finding the sequence in which the trace information items of those operating systems are actually generated.

This is a continuation of U.S. patent application Ser. No. 09/914,814, filed Oct. 22, 2001, the entire disclosure of which is incorporated herein by reference.

### TECHNICAL FIELD

The present invention relates to a system for managing information item of a plurality of operating systems. More particularly, the present invention relates to a system for managing and editing/displaying trace log information of a plurality of operating systems (hereafter, to be abbreviated as OS in some cases).

### BACKGROUND ART

In the case of a system for executing processes under the control of a plurality of different operating systems in accordance with a real time processing, a general information processing, an interchanging processing between old and new items, and other processes, the user will wish to manage the operations of those operating systems consistently.

This is why conventional operating system management systems, when managing trace log information items, have enabled each of those operating systems to execute a trace log editing/displaying program and have trace log information in itself. And, as disclosed in the official gazette of Unexamined Published Japanese Application No. 9-134300, when editing error log information items collected by a plurality of operating systems installed in a plurality of host computers, those conventional systems have used a well-known method, which sorts and merges such error log information items sequentially in order of times at which they are generated.

However, each operating system makes time management by its own way and usually calculates an elapsed time with use of a timer interruption, etc., thereby updating the time managed by itself. Consequently, such the time managing method has been divided clearly into two types; the times of all the operating systems are adjusted to the time of any one of those operating systems as disclosed in the official gazette of Unexamined Published Japanese Application No. 6-332568 and/or No. 5-307424 or the times of all those m the time of a reference operating system.

However, the time management method differs among types of operating systems. If a plurality of operating systems are running in a computer, therefore, the interruption processing method and the processing timing will also differ among those operating systems. And accordingly, the times managed by those operating systems do not agree to each another. Consequently, event trace log information items collected by those operating systems cannot be merged in order of times at which they are generated through an arithmetic operation performed by an operator or a computer as disclosed in the above conventional technology. This is because the times of managed by those operating systems are different from each another.

Under the circumstances, it is an object of the present invention to provide an operating system management system for enabling each operating system to manage its time by itself and managing a sequence of events generated among those operating systems accurately.

### DISCLOSURE OF THE INVENTION

In order to achieve the above object, the operating system management system of the present invention manages the correspondence among the times managed by a plurality of operating systems running in one computer. Consequently, traces, which become check points, are recorded in the trace information of those operating systems so that those check points are regarded to have been generated approximately at the same time. In addition, the operating system management system of the present invention adds a counter value to the trace information of each of those operating systems as additional information and manages the correspondence among the times managed by those operating systems running in one computer.

The operating system management system is provided with means for editing/displaying a trace information sequence of events in order they are generated and recorded by those operating systems in order their events are generated according to the correspondence among the traces to be assumed as check points, added counter values, or times managed by those operating systems. When displaying event data items related to a plurality of operating systems, the management system adjusts the sequence for displaying events according to the correspondence among those events in those operating systems so as to adjust the sequence of the times of those events.

### BRIEF DESCRIPTION OF THE DRAWINGS

FIG. 1 is an overall block diagram of a trace log management system of the present invention.

FIG. 2 is a hardware block diagram of the trace log management system of the present invention.

FIG. 3 is a schematic flowchart of the operation of the trace log management system of the present invention.

FIG. 4 is a model case for an operating system switching trace employed as a check point trace.

FIG. 5 shows how traces are displayed in the first embodiment of the present invention.

FIG. 6 shows a model case for a variation of the first embodiment.

FIG. 7 shows a model case for another variation of the first embodiment.

FIG. 8 is a block diagram of the trace log editing/displaying system in the second embodiment of the present invention.

FIG. 9 is another block diagram of the trace log editing/displaying system in the second embodiment of the present invention.

FIG. 10 shows a computer for operating a trace log editing/displaying program in another embodiment of the trace log management system of the present invention.

### BEST MODE FOR CARRYING OUT THE INVENTION

Hereunder, a description will be made in detail for the embodiments of an operating system management method of the present invention with reference to the accompanying drawings. The operating system management method is employed for a trace log editing/displaying system used to trace and display events of a plurality of operating systems.

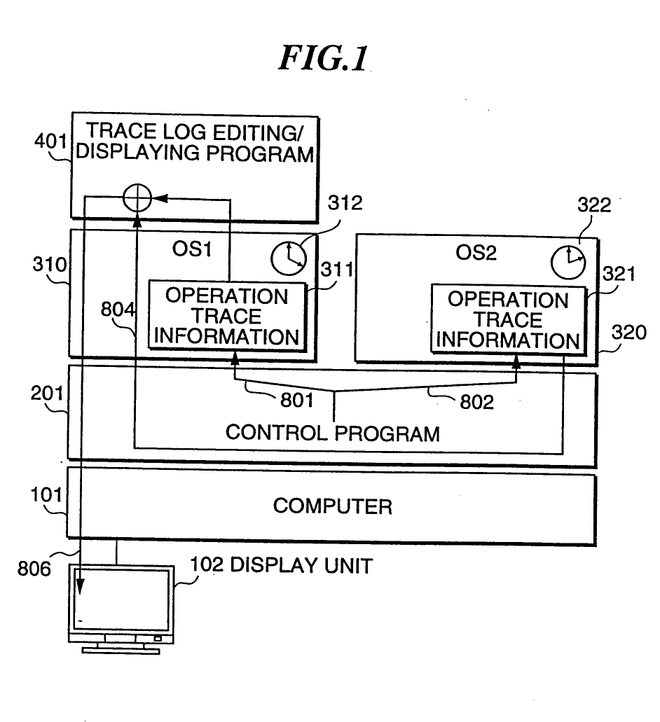

The trace log editing/displaying system in the first embodiment of the present invention is applied to a trace result to be assumed as a check point (to be referred to as a check point trace), which is an event logs corresponded to those of other operating systems as an operation information item used as a time reference of operation information items regarded to have been generated approximately at the same time among those operating systems. FIG. 1 shows a schematic block diagram of a trace log editing/displaying system of the present invention. In one computer 101 are installed the first operating system 310 (to be abbreviated as OS1) and the second operating system 320 (to be abbreviated as OS2). A control program 201 manages the operation states of a plurality of operating systems (OS1 and OS2). In this embodiment, it is premised that the OS1 and the OS2 are replaced alternately and operated in a time sharing manner. The OS1 has time information 312 managed by itself and operation trace information 311 representing the operation history thereof based on this time information 312. In the same way, the OS2 has time information 322 managed by itself and operation trace information 321. What is notable here is that the times 312 and 322 managed by OS1 and OS2 do not always agree to each other. In this embodiment, a trace log editing/displaying program 401 is operating under the control of the OS1. The program 401 edits and displays operation trace information items collected by operating systems. The program 401 can also run under the control of the OS2.

The control program 201 enables each operating system to store a check point trace in both operation trace information 311 of the OS1 and operation trace information 321 of the OS2 (801, 802). This check point trace is a trace of an event corresponded to each operating system. The check point trace is an operation information item generated commonly in both OS1 and OS2 and used as a time difference among those operating systems. Consequently, it is only required for a recorded check point trace that at least it is corresponded to each operating system. It is not required necessarily that it is recorded completely in the same way in the log of each operating system. The trace log editing/displaying program 401 reads the operation trace information 311 recorded in the OS1 and the operation trace information 321 recorded in the OS2 (803, 804). The trace log editing/displaying program 401 searches a check point trace from two operation trace information items 311 and 321. If the object check point trace is found, the program 104 finds the correspondence of the trace among the check point traces of other operating systems. Then, even when the times of the check point traces recorded by operating systems differ from each other, the trace log editing/displaying program 401 regards that the traces are generated actually at the same time, thereby editing traces included in two operation trace information items (805) and displaying the result on the display unit 102 (806).

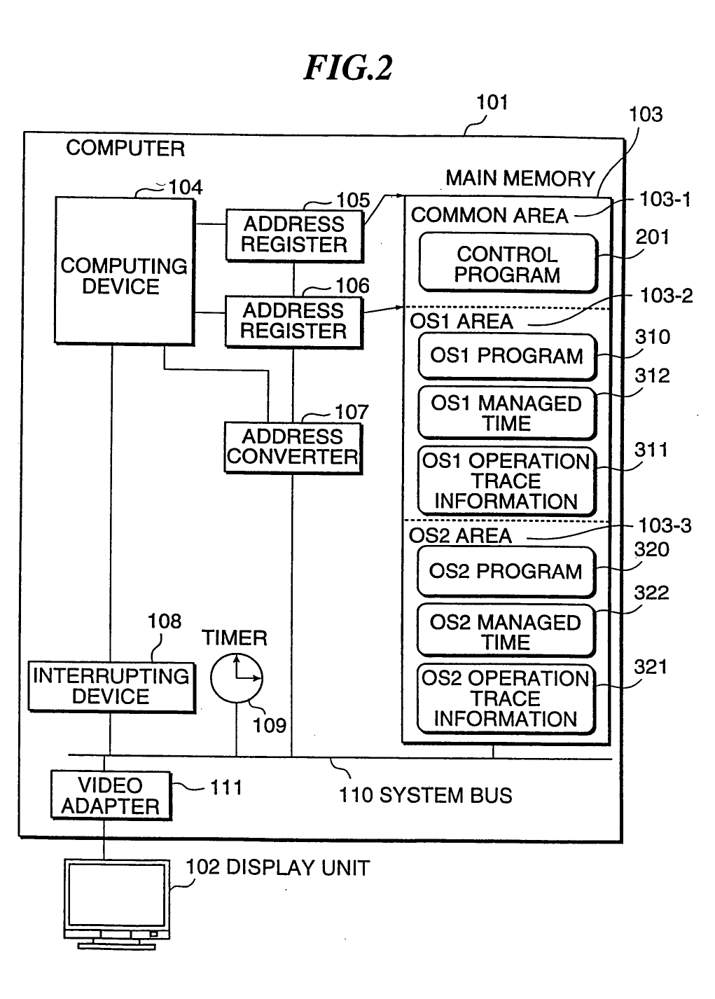

FIG. 2 is a hardware block diagram of a computer system for realizing the trace log editing/displaying system of the present invention. In this computer 101, a computing unit 104 is connected to a system bus via an address converter 107. The system bus 101 is connected to a main memory 103, an interruption device 108, a timer 109, and a video adapter 111. The video adapter 111 is connected to a display unit 102. The main memory 103 is shared by a plurality of operating systems (OS1 and OS2). The main memory 103 is roughly divided into a common area 103-1 used commonly by those operating systems, an OS1 area 103-2, and an OS2 area 103-3. The common area 103-1 stores a control program 201. The OS1 area 103-2 is a memory area used to operate the OS1. The OS1 area 103-2 stores the OS1 program 310 itself, OS1 managed time information 312, and OS1 operation trace information 311. In the same way, the OS2 area 103-3 stores the OS2 program 320 itself, OS2 managed time information 322, and OS2 operation trace information 321. And, two address registers (105 and 106) are provided and used to store the address of each area provided in the main memory. The address register 105 specifies the common area 103-1 and the address register 106 is selected by the control program 201 and it specifies an area of the present running operating system. In FIG. 2, the address register 106 specifies the OS1 area 103-2. This means that the OS1 is executed by the control program 201.

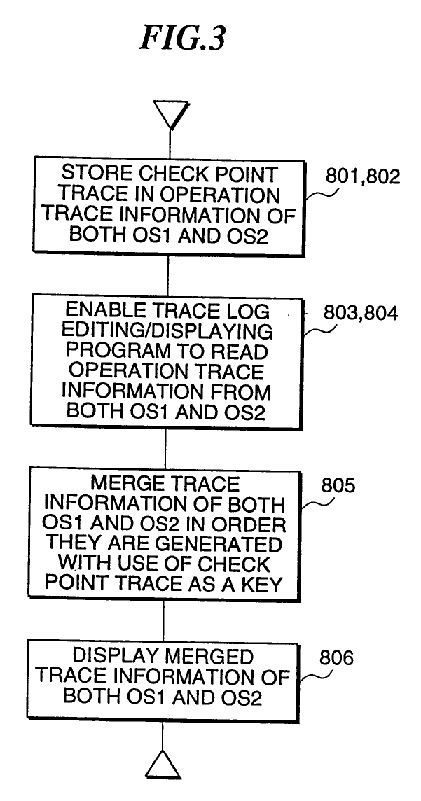

FIG. 3 shows a schematic flowchart of the operation of the trace log editing/displaying system of the present invention. At first, check point traces are stored in the OS1 operation trace information and the OS2 operation trace information beforehand (801 and 802). To display the operation trace information of both OS1 and OS2 in order they are generated, the trace log editing/displaying program reads both OS1 operation trace information and OS2 operation trace information (803 and 804). Searching the OS1 operation trace information and the OS2 operation trace information, the trace log editing/displaying program finds check point traces that are regarded to have been generated simultaneously in operating systems OS1 and OS2 from their trace information items. This trace information item is decided as a reference time of other times regarded approximately the same time in both OS1 and OS2, then both OS1 and OS2 trace information items are merged in order they are generated (step 805). The merged trace information items of both OS1 and OS2 are then displayed on the display unit (step 806).

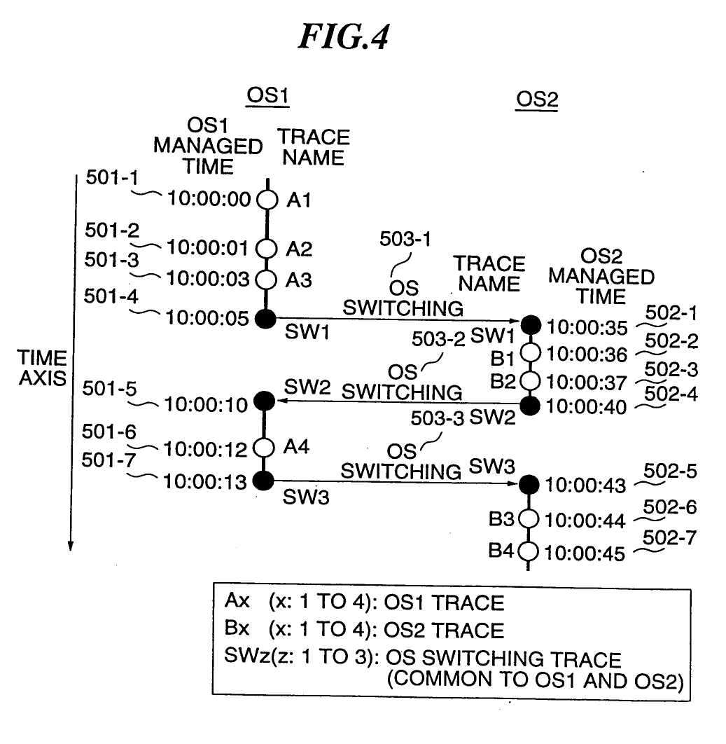

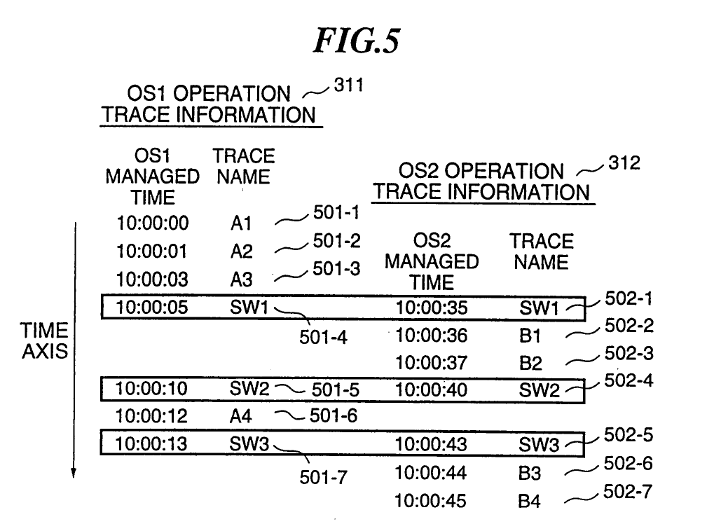

Next, a description will be made in detail for an embodiment of the control program 201 with reference to FIGS. 4 and 5. The embodiment uses an OS switching trace as a check point trace. FIG. 4 shows a model case for a series of generated traces. In FIG. 4, the time axis is taken in the vertical direction. Actual OS1 operation states are shown at the left side and actual OS2 operation states are shown at the right side. In this embodiment, the OS1 and the OS2 run in one computer in a time sharing manner. It is premised here that the control program 201 changes operating systems. Thus, the OS1 and the OS2 never run simultaneously. A trace name Ax(x: 1 to 4) is given to each trace of the OS1 and a trace name Bx(x: 1 to 4) is given to each trace of the OS2. SWz(z: 1 to 3) is given to each trace in which an operating system is switched to another, that is, a record that the state of an operating system is changed from “run” to “standby” or vice versa. This trace is common to both OS1 and OS2.

At first, A1 (501-1) was generated and traced at an OS1 managed time of 10:00:00. Then, A2 (501-2) was generated and traced at 10:00:01 and A3 (501-3) was traced at 10:00:03, both times were managed by the OS1. After that, an OS switching event was generated (503-1) at an OS1 managed time of 10:00:05 in response to the command from the control program 201 and SW1 (501-4) was recorded in an OS1 trace, thereby the present operating system OS1 was changed to OS2. At this time, the OS2 managed time was 10:00:35. This means that the OS1 managed time and the OS2 managed time are different by 30 sec from each other. The OS2 thus recorded SW1 (502-1) as a trace according to the command for restarting the operation from the control program 201. The OS2 then started its operation and recorded traces of B1 (502-2) at the OS2 managed time 10:00:36 and B2 at 10:00:37 respectively. Then, the operating system OS2 was changed to OS1 (503-2) at an OS1 managed time of 10:00:40. The OS1 managed time at that time was 10:00:10. Just like in the above case, the SW2 traces (502-4, 501-5) were recorded in both OS1 and OS2 at that time. Hereafter, the events A4(501-6), SW3(501-7, 502-5), B3(502-6), and B4(502-7) were generated as described above and their traces were recorded.

Those trace results are stored in both OS1 and OS2 operation trace information items (311 and 321) in order of times managed by those operating systems. It is premised here that each trace is stored so as to be corresponded to its given name. The trace name may be a trace code managed by the corresponding operating system or the control program 201. Consequently, A1 to A4 and SW1 to SW3 (501-1 to 501-7) are stored in the OS1 trace information in order they are generated in the OS1 together with OS1 managed times. In the same way, B1 to B4 and SW1 to SW3(502-1 to 502-7) are stored in the OS2 trace information 321 in order they are generated in the OS2 together with OS2 managed times.

The trace log editing/displaying program 401 searches an SWz(z: 1 to 3) used as a check point trace from both OS1 and OS2 operation trace information items (311 and 321). Then, if there is at least one trace between SWz and SWz+1, it is decided that an operating system having the operation trace information is running during the time in which SWz and SWz+1 are recorded. If there is no trace found between SWz and SWz+1, it is decided that another operating system is running or the original operating system is running. In this embodiment, because B1 and B2 traces are found in the OS2 operation trace information between SW1 and SW2, it is decided that the OS2 is running. And, an A4 trace is found between SW2 and SW3, it is decided that the OS1 is running. If it is considered that the OS1 and the OS2 are switched sequentially, it is decided that the OS1 is running before SW1 and the OS2 is running in and after SW3.

If check point traces are to be corresponded to each other, generated check point traces are common to both OS1 and OS2. Thus, the same number of check point traces come to be included in each of OS1 and OS2 operation trace information items at equal time intervals regardless of their managed time values. Consequently, event names or codes stored in each operation trace information are checked for agreement, as well as traces of common events assumed as check points are searched sequentially starting at the first one, thereby finding the traces that agree to each other.

FIG. 5 shows results of trace data edited and displayed by the trace log editing/displaying program in order they are generated actually according to the operation trace information 311 of the IS1 and the operation trace information 312 of the OS2. In FIG. 5, OS switching traces SWz (z=1 to 3), which are check point traces (SW1, SW2, and SW3), are displayed in a thick line frame respectively. Those OS switching traces may also be displayed in different colors. For example, SWz may be displayed in red and other traces may be displayed in black.

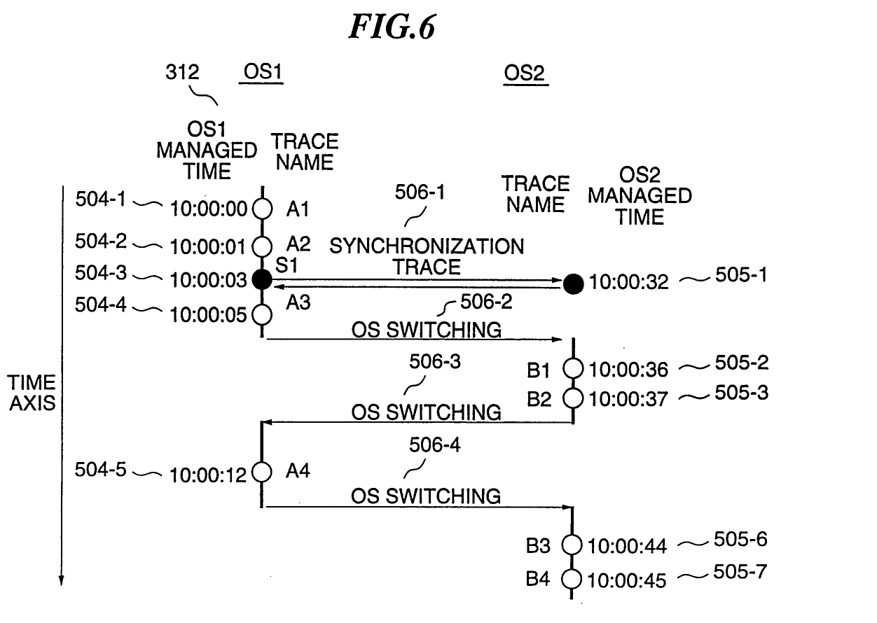

Next, a variation of the first embodiment of the present invention will be described with reference to FIG. 6. In this embodiment, a synchronization trace is employed instead of an OS switching trace (check point trace) for which the control program 201 is used. The control program 201 stores a synchronization trace at the same timing as those of the OS1 operation trace information 311 and the OS2 operation trace information 321 regardless of each OS status. Consequently, even when the OS1 managed time 312 and the OS2 managed time 322 are different from each other, a timer difference between those operating systems can be known through collation of operation trace information items of both OS1 and OS2 according to this synchronization trace information. The trace generation sequence can thus be known.

FIG. 6 shows a model case for a series of generated traces. In FIG. 6, the time axis is taken in the vertical direction. Actual operations of the OS1 are shown at the left side and those of the OS2 are shown at the right side. In this. embodiment, it is premised that OS1 and OS2 are running in one computer in a time sharing manner. Thus, OS1 and OS2 are never executed simultaneously. A trace name Ax(x: 1 to 4) is given to each OS1 trace and a trace name Bx(x: 1 to 4) is given to each OS2 trace. The trace name S1 is a synchronization trace used as a check point trace in this embodiment. The trace is common to both OS1 and OS2.

At first, the trace of A1 (504-1) is recorded at an OS1 managed time 10:00:00 and the trace of A2 (504-2) is recorded at 10:00:01. Then, the trace of a synchronization S1 (506-1) is recorded in both OS1 operation trace information and OS2 operation trace information at an OS1 managed time 10:00:02 (504-3, 505-1). At this time, the OS2 managed time was 10:00:32. Then, the trace of A3 (504-4) was recorded in OS2 at 10:00:03. After that, an OS switching event (506-2) occurred, thus control was passed to OS2. Then, the traces of B1 (505-2) and B2(505-3) were recorded in OS2 at 10:00:36 and 10:00:37 respectively. Furthermore, an OS switching event (506-3) occurred, and the trace of A4 (504-5) was recorded in OS1. After the OS switching (506-4), the traces of B3 (505-4) and B4(505-5) were recorded in OS2 respectively. After that, A1 to A4 and S1 (504-1 to 504-5) were stored as OS1 traces in the operation trace information 311 together with the OS1 managed times in order they were generated in OS1. In the same way, B1 to B4 and S1(505-1 to 505-5) were stored as OS2 traces together with OS2 managed times in order they were generated.

The trace log editing/displaying program 401, when editing/displaying an actual sequence of generated traces according to both of the operation trace information 311 of the OS1 and the operation trace information 312 of the OS2, searches a check point synchronization trace from the operation trace information items of both OS1 and OS2. Finding the synchronization trace S1 (504-3, 505-1), the program 401 decides the S1 (504-3) stored in the OS1 operation trace information 311 as a reference point. Because the S1(504-3) was generated at an OS1 managed time of 10:00:02, the relative times at which other OS1 traces were generated is calculated with reference to this time as follows.

Relative time=trace generation time−reference point generation time

It is thus found that A1 takes −2 sec, A2 takes −1 sec, A3 takes 1 sec, and A4 takes 10 sec.

The relative times of OS2 traces are also calculated in the same way. Because the reference point S1 (505-1) was generated at OS2 managed time 10:00:32, B1 takes 4 sec, B2 takes 5 sec, B3 takes 12 sec, and B4 takes 13 sec. These results are displayed so that the time axis is taken in the vertical direction (from top to bottom) and OS1 traces are shown at the left side and OS2 traces are shown at the right side. Those traces are displayed in ascending order of calculation results of the above relative times from top to bottom in the format of one trace per line. Then, the synchronization traces (504-3 and 505-1), which were generated simultaneously in both OS1 and OS2, are displayed on the same line. The synchronization traces are also displayed in a thick line frame respectively or in different colors. Consequently, traces of each OS are displayed sequentially from top to bottom in order they are actually generated.

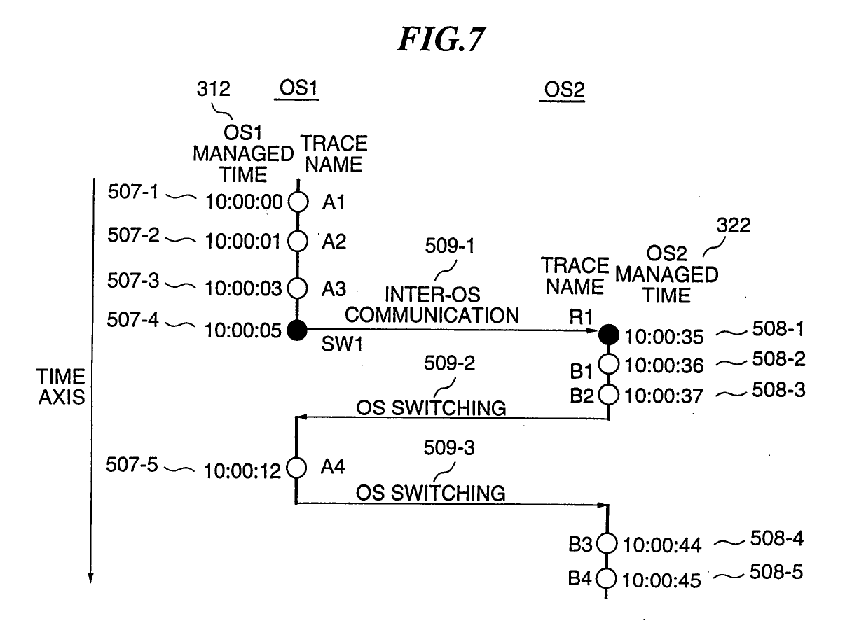

Furthermore, a description will be made for another variation of the first embodiment of the present invention with reference to FIG. 7. In this embodiment, instead of a check point trace recorded by the control program 201 as described above, an inter-OS communication trace (509-1) is used. In this embodiment, it is premised that data is transferred from OS1 to OS2. The inter-OS communication means transferring of data from the transmission program of an operating system to the receiving program of another operating system. In this case, the transmission side program records transmission traces and the receiving side program records received traces. These transmission traces and received traces are referred to as inter-OS communication traces generically. In such the inter-OS communication, transmission and receiving are corresponded to each other and both transmission program and the receiving program are executed in a synchronized manner. It is thus regarded that inter-OS communication traces recorded in both OS1 and OS2 are generated almost simultaneously. Consequently, even when the OS1 managed time and the OS2 managed time are different from each other, a time difference between those operating systems can be known through collation with the operation trace information items of both OS1 and OS2 according to this inter-OS communication trace information. This is why the sequence of generated traces can be known.

FIG. 7 shows a model case for a series of generated traces. In FIG. 7, the time axis is taken in the vertical direction. Actual OS1 operation states are shown at the left side and actual OS2 operation states are shown at the right side. In this variation of the first embodiment, it is premised that both OS1 and OS2 are executed in one computer in a time sharing manner. Therefore, OS1 and OS2 are never executed simultaneously. A trace name Ax(x: 1 to 4) is given to each OS1 trace and a trace name Bx(x: 1 to 4) is given to each OS2 trace. S1 indicates a transmission trace in inter-OS communications and R1 indicates a received trace in the inter-OS communications.

At first, the trace of A1(507-1) was recorded at an OS1 managed time 10:00:00, then A2(507-2) and A3(507-3) were recorded at 10:00:01 and 10:00:03 respectively. Then, at an OS1 managed time 10:00:05, data was transmitted (509-1) from OS1 to OS2, thereby the transmitted trace S1(507-4) was recorded as an OS1 trace. At this time, a received trace R1(508-1) was recorded as an OS2 trace at the data receiving side. After that, OS switching (509-2, 509-3) was repeated, thereby traces of A4(507-5) and B1 to B4(508-2 to 508-5) were recorded in both OS1 and OS2. During this time, A1 to A4 and S1 (507-1 to 507-5) were recorded as OS1 traces together with OS1 managed times in the OS1 operation trace information in order they were generated. On the other hand, B1 to B4 and R1(508-1 to 508-5) were recorded as OS2 traces together with OS2 managed times in the OS2 operation trace information in order they were generated.

The trace log editing/displaying program 401 edits and displays actually generated traces in order they are generated according to the OS1 operation trace information 311 and the OS2 operation trace information 312. Consequently, the program 401 searches a pair of inter-OS communication traces to be assumed as check points from the operation trace information items of both OS1 and OS2. In this case, if a trace S1(507-4) corresponding to a transmission event is found from the OS1 operation trace information and a trace R1(508-1) corresponding to an received event from the OS2 operation trace information, then the S1(507-4) stored in the OS1 operation trace information is decided as a reference point. The S1 was generated at an OS1 managed time 10:00:05. This time is used as a reference point so as to calculate the relative times of A1 to A4 as follows.

Relative time=trace generated time−reference point generated time

It is thus found that A1 takes −5 sec, A2 takes −4 sec, A3 takes −2 sec, and A4 takes 7 sec. In the same way, relative times of B1 to B4 in OS2 are calculated and found as follows. The reference point is decided by regarding that a trace R1(508-1) is generated together with S1(507-4) at the same time. Because the OS2 managed time is 10:00:35 at that time, B1 takes 1 sec, B2 takes 2 sec, B3 takes 9 sec, and B4 takes 10 sec. The above results are displayed so that the time axis is taken in the vertical direction (from top to bottom) and OS1 traces are shown at the left side and OS2 traces are shown at the right side. The traces are also displayed in the format of one trace per line in ascending order of calculation results of the above relative times. Since the inter-OS traces are generated simultaneously in both OS1 and OS2, they are displayed on the same line. The synchronization traces may also be displayed in a thick line frame respectively or in different colors.

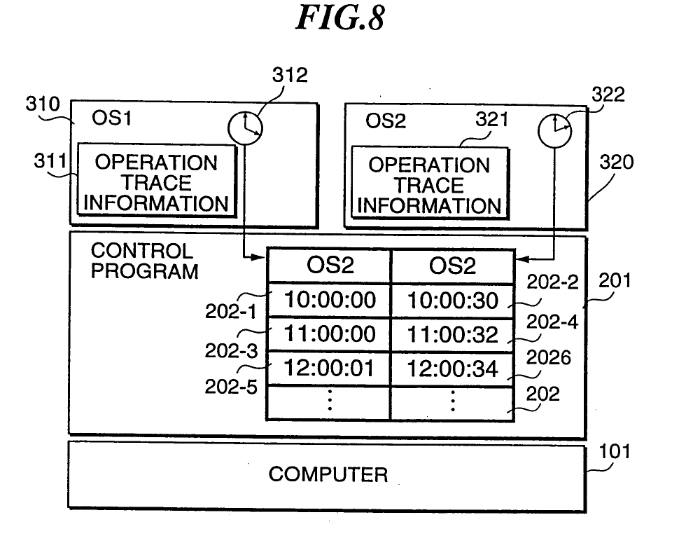

Next, a description will be made for the trace log editing/displaying system in the second embodiment of the present invention with reference to FIG. 8. In this embodiment, a difference between OS1 and OS2 managed times is used to edit and display trace information of both OS1 and OS2. FIG. 8 is an overall block diagram of the trace log editing/displaying system in the second embodiment. In this second embodiment of the present invention, a control program 201 stores information related to a difference between OS1 and OS2 managed times as an inter-OS time difference 202.

It is premised here that the control program 201 reads the times managed by both OS1 and OS2 simultaneously and writes the time difference between OS1 and OS2 managed times in the time lag information 202. In this embodiment, it will be found that the OS2 managed time is 10:00:30 (202-2) when the OS1 managed time is 10:00:00(202-1) and the OS2 managed time is 11:00:32 (202-4) when the OS1 managed time is 11:00:00(202-3), and the OS2 managed time is 12:00:34 (202-6) when the OS1 managed time is 12:00:01(202-1).

In this second embodiment, neither the OS1 operation trace information 311 nor the OS2 operation trace information 312 includes any check point trace. If traces are edited and displayed sequentially in order they are actually generated according to the time lag information and the operation trace information of both OS1 and OS2, the OS2 time in an OS1 time can be known from the time lag information 202. With use of this time difference as a reference point, relative times of generated traces in the operation trace information of both OS1 and OS2 are calculated as follows.

Relative time=trace generation time−reference point generation time

The relative time of each generated OS2 trace is also calculated in the same way. The calculation results are then displayed so that the time axis is taken in the vertical direction (from top to bottom) and OS1 traces are shown at the left side and OS2 traces are shown at the right side. The sequence of those traces in generation is displayed in ascending order of calculation results (from top to bottom) in the format of one trace per line. OS1 traces and OS2 traces may also be displayed in different colors for easier distinction. For example, OS1 traces may be displayed in green and OS2 traces may be displayed in red. In this second embodiment, when comparing an OS1 trace with an OS2 trace, it is required that the object trace recording time band is found from the time lag information 202, then the found time band is compensated accordingly. As this time lag information, the control program 201 can read the times from both OS1 and OS2 and stores them as they are, as well as the program 201 can store the time difference as a time deviation.

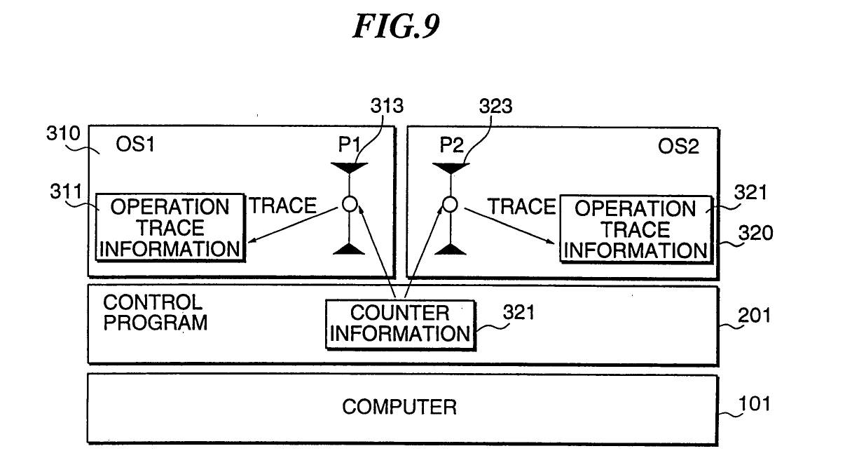

Next, a description will be made for the third embodiment of the trace log editing/displaying system of the present invention with reference to FIG. 9. In this embodiment, counter information is used to edit and display the trance information items of both OS1 and OS2. In this case, because each trace recorded in each OS is corresponded to the counter information 203 managed by the control program 201, the order of each trace is decided uniquely in each of the OS1 and OS2.

FIG. 9 shows an overall block diagram of the trace log editing/displaying system when counter information is used. The control program 201 has counter information 203 in itself. It is premised here that when the program P1(313) in the OS1 or the program P2(323) in the OS2 records a trace, the present counter value is read from the counter information 203 set in the control program 201. The read counter value is then stored in the trace information of both OS1 and OS2 together with the trace data by the program P1 or P2 in the OS1 or OS2. The counter information 203 in the control program 201 is incremented by one each time it is read. In the operation trace information (311, 312) of both OS1 and OS2 are recorded OS time information, trace data, and the counter value respectively. Because the counter value is incremented by one each time a trace is recorded, a trace with a smaller value is generated earlier than a trace with a larger value. Consequently, if operation trace information items of both OS1 and OS2 are merged and the counter values are sorted in ascending order, then traces are listed up in order they are actually generated. Unlike the above embodiments, it is no need to search the correspondence among check point traces in this second embodiment.

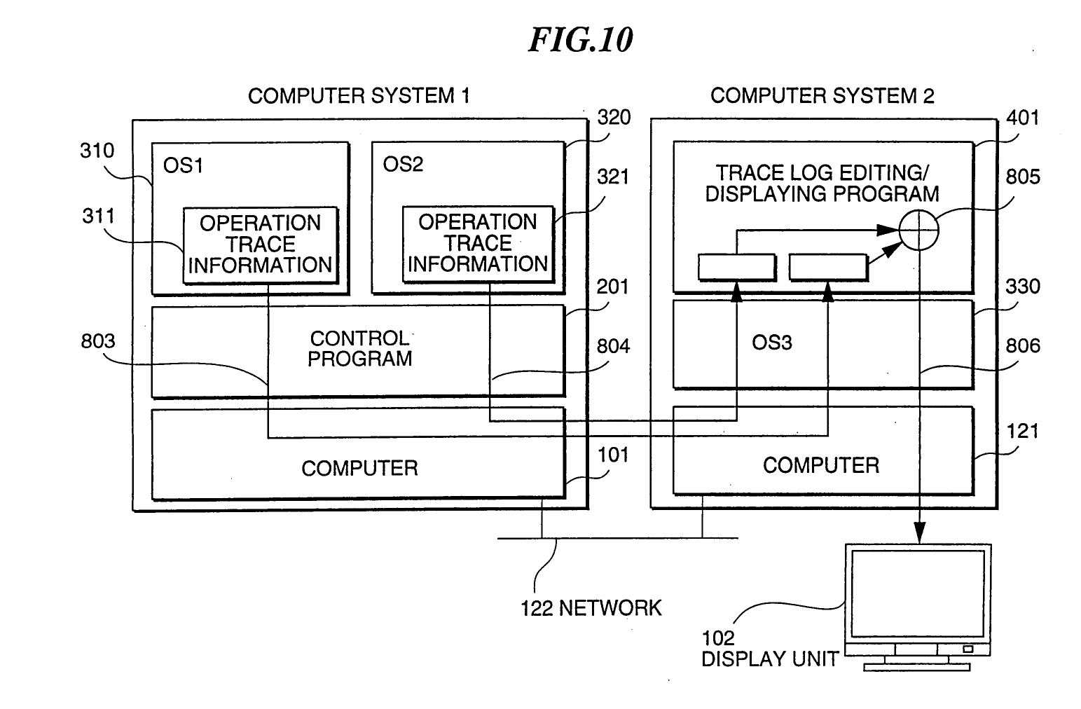

Next, a description will be made for the trace log editing/displaying system of the present invention in another embodiment with reference to FIG. 10. In this embodiment, it is premised that the trace log editing/displaying program 401 is executed in another computer. A computer system 1 operates so that a control program 201 switches the operating system between OS1 (310) and OS2 (320) installed in a computer 101. Each of the OS1 and the OS2 has operation trace information (311, 321). The computer system 2 in which the trace log editing/displaying program 401 is executed is hardware, which is different from the computer system 1 and OS3 (330) is running in the computer 121. The computer 121 is connected to a display unit 102 for displaying traces. The computer 101 and the computer 121 are connected to each other via a network 122 so as to transfer operation trace information between them. Such a data storing medium as a floppy disk, etc. may also be used as means for transferring such operation trance information.

The trace log editing/displaying program 401 installed in the computer system 2 reads operation trace information items 311 and 321 of both OS1 and OS2 via the network 122 (803, 804), then edits traces transferred from two operation trace information items 311 and 312 in accordance with the same method of the first embodiment (805) and displays the result on the display unit 102 (806).

Although the operation trace information items of both OS1 and OS2 are managed by both OS1 and OS2 in the above embodiment, it is also possible to store those operation trace information items collectively in a common area. In such a case, the control program 201 is provided with a sub-routine program for storing traces in the operation trace information of both OS1 and OS2 in the common area, so that the sub-routine program is used as an interface program executed from both OS1 and OS2. A program for recording traces in OS1 executes this sub-routine, thereby recording OS1 traces in both OS1 and OS2 operation trace information. In the same way, a program for recording traces in OS2 executes this program, thereby recording OS2 traces in both OS1 and OS2 operation trace information. Consequently, traces are recorded in both OS1 and OS2 operation trace information items in order they are actually generated.

On the other hand, a program for recording traces in OS1 and a program for recording traces in OS2 may also store those traces directly in both OS1 and OS2 operation trace information items in the common area without using such a sub-routine.

Industrial Applicability

As described above, the operating system management system of the present invention can manage times of events generated in a plurality of operating systems in an unified manner while each of those operating systems has its own managed time that is different from others and manages traces of each of those operating systems sequentially in order they are generated. Consequently, the management system of the present invention can have an effect that error analysis and debugging in development can be done efficiently in a computer system in which a plurality of operating systems are running. The system will thus be very suitable for managing a computer system in which a plurality of operating systems are running.

1. An operating system management method for managing a plurality of operating systems, comprising the steps of:
enabling each of a plurality of said operating systems to record its operation information item corresponded to operation information items of other operating systems and to be assumed as a reference of operation information items of those other operating systems, regarded to have been generated approximately at the same time;
finding the correspondence of an operation information item to be assumed as a reference of said approximately same times from operation information items recorded by said other operating systems; and
finding a sequence of operation information items recorded by said other operating systems according to said found correspondence.

2. An operating system management method for managing a plurality of operating systems, comprising the steps of:
enabling each of a plurality of said operating systems to record its operation information item corresponded to operation information items of said other operating systems and to be assumed as a reference of said other operation information items regarded to have been generated approximately at the same time with reference to a counter value to be updated when an operation information item of said operating system is recorded; and
finding a sequence of recorded operation information items in order they are generated with use of a size of said counter value added to said operation information of each of a plurality of said operating systems.

3. An operating system management method comprising the steps of:
recording operative information connected with the operative circumstances of another operating system;
acquiring from said recorded operative information operative information which becomes a reference for time; and
performing operating management on the basis of said acquired information.
